(19) United States
(12) Patent Application Publication
(10) Pub. No.: US 2003/0105218 A1
(43) Pub. Date: Jun. 5, 2003

(54) Room temperature curable oil resistant elastomer coating

(75) Inventors: James R. Halladay, Harborcreek, PA (US); Frank J. Krakowski, Erie, PA (US)

Correspondence Address: Miles B. Dearth, Lord Corporation, 111 Lord Drive, P.O. Box 8012, Cary, NC, 27512-8012, US

(73) Assignee: Lord Corporation

(21) Appl. No.: 09/990,149

(22) Filed: Nov. 21, 2001

(51) Int. Cl. C08J 3/00

(52) U.S. Cl. 524/589

(57) ABSTRACT

The coating composition of the invention cures at room temperature, and forms a coating which is resistant to flex-fatigue, corrosive materials, environmental temperature variability and provides for excellent adhesion to flexible elastomeric substrates. The coating comprises (A) a hydrogenated acrylonitrile-butadiene copolymer, (HNBR) (B) a phenolic resin, (C) a di- or polyisocyanate, (D) a curing component, and (E) a solvent.

### FIELD OF THE INVENTION

The present invention relates to protective coatings on elastomers.

### BACKGROUND OF THE INVENTION

Elastomeric materials are utilized in numerous industrial applications. For example, elastomeric materials are utilized in the manufacture of various hoses, seals, and insulating devices found in the engines of automobiles and other vehicles. In addition, devices for mounting the engines within these vehicles typically comprise one or more metal parts adhesively bonded to one or more elastomeric parts. In these and many other industrial applications utilizing elastomeric materials, the elastomeric materials are typically exposed to corrosive and degrading materials such as various solvents, oils and fuels. Elastomeric materials have a tendency to degrade when exposed to these types of materials, and there is a continuing search within the elastomer industry to create an elastomer which is resistant to corrosive materials.

One method of rendering elastomeric materials resistant to corrosive materials is to apply a protective coating to the elastomeric material. Various corrosion-resistant coatings previously utilized for both flexible substrates (e.g., elastomeric substrates) and rigid substrates (e.g., steel, stainless steel, aluminum or plastic) include polyurethanes, polysulfides and fluorocarbon elastomers. When applied to rigid substrates, traditional corrosion-resistant coatings such as fluorocarbon elastomers have been found to provide excellent resistance to oil and fuel. However, when applied to flexible elastomeric substrates such as natural rubber or polybutadiene, the fluorocarbon elastomers suffer from poor fatigue resistance, poor low temperature characteristics, and poor adhesion to the natural rubber or polybutadiene substrate.

U.S. Pat. No 4,774,288 discloses a hydrogenated copolymer of a conjugated diene and an α,β-unsaturated nitrile containing an active phenol-formaldehyde resin vulcanization system. The disclosure is directed to the bulk vulcanizate, which is characterized as having good compression set properties and a good resistance to oils and good resistance to oxidative attack in air at elevated temperature aging under oxidizing conditions, however no mention is made suggesting that solvent borne coatings could be formed on flexible elastomeric substrates such as natural rubber and polybutadiene which might provide useful properties.

U.S. Pat. No. 5,314,955 discloses a coating composition consisting of (a) a hydrogenated acrylonitrile-butadiene copolymer, (b) a phenolic resin, (c) a curing component, and (d) a solvent. This coating solves many of the problems of adhesion to rubber substrates combined with fatigue resistance and fuel resistance. One of the drawbacks of this coating composition is that it requires a high temperature bake to cure the coating and to promote adhesion to adjacent metal surfaces. Some parts such as helicopter rotor bearings are damaged by the high temperature bake. The high temperature bake is also costly in production since it adds a time delay and additional handling of the parts. There still exists a need for improved protective coatings for flexible elastomeric substrates such as natural rubber and polybutadiene that can be applied without additional high temperature exposure, but provide long-term flexibility, fatigue resistance over a broad service temperature range, and that exhibit effective adhesion to the substrate.

### SUMMARY OF THE INVENTION

The coating composition of the invention is resistant to fatigue and temperature variability and provides for excellent adhesion to flexible elastomeric substrates and it cures at room temperature. More specifically, the coating composition of the invention comprises (A) a hydrogenated acrylonitrile-butadiene copolymer, (HNBR) (B) a phenolic resin, (C) a di- or polyisocyanate, (D) a curing component, and (E) a solvent. The present invention provides coatings having excellent adhesion to the elastomer substrate, resistance to corrosive materials and resistance to fatigue over a wide temperature range.

### DETAILED DESCRIPTION OF THE INVENTION

(A) HNBR

The hydrogenated acrylonitrile-butadiene copolymer of the invention are commercially available, for example from Zeon Chemical. These are typically prepared by hydrogenating an acrylonitrile-butadiene copolymer which has been prepared by reacting a conjugated diene and an unsaturated nitrile. The conjugated dienes useful for preparing the acrylonitrile-butadiene copolymers to be hydrogenated can be any of the well-known conjugated dienes including 1,3-butadiene; 2,3-dimethyl-butadiene; 1,3-pentadiene; 1,3-hexadiene; 2,4-hexadiene; 1,3-heptadiene; piperylene; and isoprene, with 1,3-butadiene presently being preferred.

The unsaturated nitrites useful for preparing the acrylonitrile-butadiene copolymers typically correspond to the following formula:

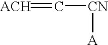

wherein each A is hydrogen or a hydrocarbyl group having from 1 to about 10 carbon atoms. Examples of A groups include alkyl and cycloalkyl, such as methyl, ethyl, isopropyl, t-butyl, octyl, decyl, cyclopentyl, cyclohexyl, etc., and aryls such as phenyl, tolyl, xylyl, ethylphenyl, t-butylphenyl, etc. Acrylonitrile and methacrylonitrile are the presently preferred unsaturated nitrites.

The copolymers are prepared by the reaction of the conjugated diene and unsaturated nitrile monomers in the presence of a free radical initiator by methods well known to those skilled in the art. Suitable free radical initiators or catalysts include organic oxides, peroxides, hydroperoxides, azo compounds, etc., such as hydrogen peroxide, benzoyl peroxide, cumene hydroperoxide, di-tert-butyl peroxide, ascaridole, acetyl peroxide, tert-butyl hydroperoxide, trimethylamine oxide, dimethylaniline oxide, isopropylperoxydicarbonate, diisobutylene ozonide, peracetic acid, nitrates, chlorates, perchlorates, azobisisobutyronitrile, etc. Suitable concentrations of the catalysts are between about 0.0001 and 5 percent and preferably between about 0.001 and 1 percent by weight of the total reaction mixture.

The commercially available HNBR is made from starting nitrile-diene polymer that is typically hydrogenated in two steps, whereby the carbon-to-carbon double bonds are first reduced, followed by reduction of the carbon-to-nitrogen bond. This procedure avoids the gelation of the hydrogenated polymers which may occur if the reduction is carried out in one step. In the first step, a different catalyst may be used, for example, a palladium or ruthenium catalyst. If desired, however, the nitrile groups alone may be reduced by proper choice of the catalyst, leaving unsaturated carbon-to-carbon bonds in the linear polymeric chain. It is possible also to use a combination of noble metal and nickel or cobalt, operating first at a relatively low temperature, then at a higher temperature. Other techniques for hydrogenating acrylonitrile-butadiene copolymers are disclosed in, for example, U.S. Pat. Nos. 4,581,417; 4,631,315; and 4,795,788; the disclosures of which are incorporated herein by reference.

The acrylonitrile-butadiene copolymers are typically hydrogenated to an extent such that the final product has an unsaturation level of from about 0.1 to 20 mole percent, preferably from about 3 to about 7 mole percent.

Hydrogenated NBR is commercially available from Nippon Zeon (Zetpol®) and Bayer Corporation (Therban®).

(B) Phenolic Resin

The phenolic resins useful in the present invention can be any of the well known phenolic resins prepared, for example, by reacting a phenolic compound with an aldehyde compound under acidic, neutral or basic conditions with an appropriate catalyst. Phenolic resins useful in the invention include unmodified phenolic resins, cashew-modified phenolic resins, epoxy-modified phenolic resins, and elastomer-modified phenolic resins.

The phenolic compound useful for preparing suitable phenolic resins can be monohydroxy or multihydroxy phenolic compounds which may be substituted with groups such as alkyl, alkoxy, amino, halogen and the like. Examples of phenolic compounds useful in the invention include phenol, p-t-butylphenol, p-phenylphenol, m-bromophenol, o-chlorophenol, p-chlorophenol, p-alkoxyphenol, o-cresol, m-cresol, p-cresol, 2-ethylphenol, amylphenol, nonylphenol, xylenol, naphthol, carvacrol, cashew nutshell liquid, resorcinol, orcinol, phloroglucinol, pyrocatechol, pyrogallol, salicylic acid, bisphenol A, bisphenol S, combinations thereof, and the like, with phenol being presently preferred.

The aldehyde compound useful for preparing the phenolic resins of the present invention can be any aldehyde compound previously known for this purpose. Examples of aldehyde compounds useful in the invention include formaldehyde, acetaldehyde, propionaldehyde, isobutyraldehyde, 2-ethylbutrylaldehyde, 2-methylpentaldehyde, and 2-ethylhexaldehyde. The aldehyde compound of the invention may also be any of the other various forms of formaldehyde, including compounds which decompose to formaldehyde such as paraformaldehyde, trioxane, furfural, hexamethylenetetramine, benzaldehyde, and the like. The aldehyde compound can also be any of the acetals which liberate formaldehyde upon heating. Formaldehyde is the presently preferred aldehyde compound.

The phenolic resin is utilized in an amount ranging from about 3 to 50 percent by weight, preferably from about 5 to 15 percent by weight, of the hydrogenated acrylonitrile-butadiene copolymer. In terms of weight parts per 100 weight parts of film forming hydrogenated NBR elastomer (“phr”), the phenolic resin is present at from 3phr to 50 phr, preferably from 5 phr to 15 phr. The lower limit of phenolic resin of 3 phr is critical, as below this limit, insufficient curing occurs. The preferred phenolic resins of the present invention are thermosetting phenol-formaldehyde resins. Commercial versions are available from Occidental Chemical Corporation under the tradename DUREZ®, with DUREZ(D 12687 being preferred.

(C) Di- or Polyisocyanates

The di- and polyisocyanates include aliphatic, cycloaliphatic and aromatic isocyanate functional compounds. Aromatic polyisocyanates are preferred. Specific examples of di- or polyisocyanates include, without limitation, aliphatic polyisocyanates such as 1,6-hexamethylene diisocyanate; 1,8-octamethylene diisocyanate; 1,12-dodecamethylene diisocyanate; 2,2,4-trimethylhexamethylene diisocyanate, and the like; 3,3′-diisocyanatodipropyl ether; 3-isocyanatomethyl-3,5,5′-trimethylcyclodexyl isocyanate; hexamethylene diisocyanate; 4,4′-methylenebis(cyclohexyl isocyanate); cyclopentalene-1,3-diisocyanate;cyclodexylene-1,4,-diisocyanate; methyl 2,6-diisocyanatocaprolate; bis-(2-isocyanatoethyl)-fumarate; 4-methyl-1,3-diisocyanatocyclohexane; trans-vinylene diisocyanate and similar unsaturated polyisocyanates; 4,4′-methylene-bis(cyclohexylisocyanate) and related polyisocyanates; methane diisocyanates; bis-(2-isocyanatoethyl) carbonate and similar carbonate polyisocyanates; N,N′,N″-tris-(6-isocyanatohexamethylene)biuret and related polyisocyanates. Aromatic di- and polyisocyanates include toluene diisocyanates; xylene diisocyanates;dianisidine diisocyanate; 4,4′-diphenylmethane diisocyanate;1-ethoxy-2,4-diisocyanatobenzene;1-chloro-2,4-diisocyanatobenzene; bis(4-isocyanatophenyl)methane; tris(4-isocyanatophenyl)methane; naphthalene diisocyanates; 4,4′-biphenyl diisocyanate; phenylene diisocyanates such as m- and p-phenylene diisocyanate; 3,3′-dimethyl-4,4′-biphenyl diisocyanate; p-isocyanatobenzoyl isocyanates; tetrachloro-1,3-phenylene diisocyanate; 2,4-toluene diisocyanate, 2,6-toluene diisocyanate, 4,4′-isocyanate, bis-[isocyanatopheny] methane polymethylene poly(phenyl isocyanate), isophrone diisocyanate, and other aliphatic, heterocyclic and aromatic polyisocyanates, and including mixtures of such polyisocyanates. Exemplary commercial products are trimethylhexamethylene diisocyanate available from VEBA, heptadecyl (C17) diisocyanate, DDI 1410 an aliphatic C-36 diisocyanate available from the Henkel Corporation of Minneapolis, Minn and Isonate® 143L diisocyanate, a modified diphenylmethane diisocyanate (MDI) available from Upjohn Corp. Further urethane components are isophorone diisocyanate available from VEBA and Desmodur® N an aliphatic triisocyanate available from Mobay. Desmodur® N is more particularly defined as the reaction product of 3 moles of hexamethylene diisocyanate and water having an isocyanate equivalent weight of 191. Other adducts or prepolymers of the polyisocyanate include Desmodur® L and Mondur® CB which are the adducts of tolylene diisocyanate (TDI).

The amount of di- or polyisocyanate included should be from 3 to 30 phr.

Preferably the amount is from 8 to 15 phr.

(D) Curing Component

The curing component of the present invention are the conventional vulcanization cure systems or a system capable of crosslinking with both the remaining unsaturation of the hydrogenated acrylonitrile-butadiene copolymer and the inherent unsaturation of the elastomeric substrate to be coated. The preferred curing component of the invention comprises elemental sulfur. The sulfur vulcanizing agents (or sulfur-containing vulcanizing agents) include, for example, elemental sulfur such as powder sulfur, precipitated sulfur, colloidal sulfur, insoluble sulfur, highly dispersible sulfur and sulfur-providing compounds such as polysulfide rubbers disclosed in, for example, “Rubber Industry Text Book (new edition) page 169 published by the Japanese Rubber Association on Nov. 15, 1973”, and in Rubber Chemistry & Technology, vol. 68, Issue 5, Nov.-Dec., 1995. Examples of suitable sulfur vulcanizing agents include sulfur donating vulcanizing agents, for example, an amine disulfide, polymeric polysulfide or sulfur olefin adducts. Preferably, the sulfur vulcanizing agent is elemental sulfur. As known to those skilled in the art, an elastomer curing component, in general, can be used in an amount ranging from 0.1 to 12 phr, particularly from about 0.5 to about 4 phr, or even, in some circumstances, up to about 8 phr.

With respect to the preferred curing component of the invention, the sulfur vulcanizing agents are typically utilized in an amount ranging from about 0.1 to 4 phr, preferably from about 0.5 to 1.5 phr of the hydrogenated acrylonitrile-butadiene copolymer.

More preferably the curing component is combined with an optional accelerator. The organic accelerator can be any organic compound or material known to accelerate crosslinking reactions with elastomeric materials and include derivatives of dialkyl, alkylcycloalkyl, or alkylaryl dithiocarbamic acids; e.g., zinc dimethyldithiocarbamate and N-pentamethylene-ammonium-N′-pentamethylenedithiocarbamate, derivatives of alkyl or aryl xanthogenic acids, e.g., zinc isopropyl xanthate, derivatives of thiuram sulfide, e.g., dibenzothiazyl disulfide (MBTS) and sulfenamides based on MBT, such as e.g. benzothiazyl-2-cyclohexylsulfenamide (CBS), benzothiazyl-2-dicyclohexylsulfenamide (DCBS), benzothiazyl-2-tert-butylsulfenamide (TBBS) and benzothiazyl-2-sulfenemorpholide (MBS).

The vulcanization accelerators when used are employed in amounts of 0.1 to 8 phr, preferably 0.2 to 3.0 phr, more preferably in amounts of 0.5 to 2.5 phr (on wt. basis of HNBR). A single accelerator system may be used, i.e., primary accelerator. Mixtures of vulcanization accelerators can also be employed, it being possible for the optimum composition of these in respect of type and amount to be determined easily by experiments. For example, a combination of zinc dimethyldithiocarbamate and benzothiazyl disulfide is useful. Thus, a combination of a primary and a secondary accelerator might be used with the secondary accelerator present in smaller amounts (of about 0.05 to about 3 phr). Alternatively a delayed action accelerator may be used which are not affected by normal processing temperatures but produce a satisfactory cure at ordinary vulcanization temperatures. Vulcanization retarders might also be used. Suitable types of accelerators that may be used in the present invention are amines, disulfides, guanidines, thioureas, thiazoles, thiurams, sulfenamides, dithiocarbamates and xanthates. Preferably, the primary accelerator is a disulfide or sulfenamide. If a second accelerator is used, the secondary accelerator is preferably a guanidine, dithiocarbamate or thiuram compound.

(E) Solvent

The solvent useful as the carrier vehicle for the coating composition of the present invention can essentially be any organic solvent or other material known to dissolve acrylonitrile-butadiene copolymers. Examples of organic solvents useful in the present invention include ketones such as methylethyl ketone, methylisobutyl ketone, and diisobutyl ketone; acetates such as butyl acetate; toluene, xylene and their derivatives; nitropropane; and ethylene dichloride.

The solvent of the present invention is typically utilized at 70% to 95% by weight of the total coating composition, and preferably from 80% by weight to 90% by weight such that the coating composition has a total solids content ranging from about 5 to 30 percent, and preferably from about 10 to 20 percent.

The coating composition of the present invention may contain other optional ingredients such as metal oxides, antioxidants and particulate reinforcements. Representative antioxidants may be, for example, diphenyl-p-phenylenediamine and others, such as, for example, those disclosed in The Vanderbilt Rubber Handbook (1978), Pages 344 through 346. Specific examples of conventional metal oxides include zinc oxide, magnesium oxide, and lead oxide, while specific examples of particulate reinforcements useful in the invention include carbon black, precipitated silica, and fumed silica. The optional particulate reinforcement may be utilized in various amounts up to about 50 percent by weight of the hydrogenated acrylonitrile-butadiene copolymer.

The coating composition may be prepared by simply mixing the ingredients by hand with a spatula or the like or by mechanical mixing or shaking. The coating composition is typically applied to an elastomeric material and/or other substrate by dipping, spraying, wiping, brushing or the like, after which the coating is allowed to dry for a period of time typically ranging from about 30 minutes to 2 hours, preferably from about 45 minutes to 1 hour. The coating composition is typically applied to form a dry layer on the substrate having a thickness ranging from about 0.1 to 5 mils, preferably from about 0.5 to 1.5 mils.

The coating composition typically cures within about 48 to 72 hours at room temperature. The cure can be accelerated by exposing the coating to elevated temperatures, but this is not required.

Substrates

The coating composition of the present invention is particularly suitable for coating engine mounting devices which are comprised of vulcanized elastomeric parts that have been bonded to metal parts.

The elastomeric surface or substrate to be coated may optionally be pretreated with a chlorinating agent such as sodium hypochlorite and hydrochloric acid. The use of various chlorinating agents to prepare elastomeric materials for application of a coating composition is well known in the art. One example of a chlorinating agent is commercially available from Lord Corporation under the tradename CHEMLOK 7701. The chlorinating agent may be applied to the surface of the elastomeric material by brushing, dipping, spraying, wiping, or the like, after which the chlorinating agent is allowed to dry. Chlorinating agents tend to be very volatile and typically dry within a matter of seconds or minutes.

The coating compositions of the present invention have the surprising ability to adequately bond to both the flexible elastomeric part and the rigid metal part so that the boundary between the elastomer and metal can be adequately protected by the coating composition. The present invention is therefore distinguished from many traditional protective coating compositions which only have the ability to bond to one type of substrate to be protected.

The following examples are provided for purposes of illustrating the present invention and shall not be constructed to limit the scope of the invention which is defined by the claims.

### EXAMPLE 1

A coating solution was prepared as follows.

| Ingredient | Description | CAS number | PHR |
|---|---|---|---|
| Zetpol ® 2020L | hydrogentated nitrile-butadiene | 88254-10-8 | 100.0 |
| Kadox ® 911C | Zinc oxide | 1314-13-2 | 5.0 |
| Flectol ® H | TMQ antioxidant | 26780-96-1 | 1.0 |
| N330 HAF | Carbon Black | 1333-86-4 | 10.0 |
| Durez ® 12687 | Phenolic resin | 67700429 | 10.0 |
| Devil ® AA | Sulfur | 7704-34-9 | 1.0 |
| MBTS | 2,2′ Dibenzothiazyl disulfide | 120-78-5 | 0.5 |

The above solids formulation (127.5 wt. parts) were dissolved in 601 wt. parts of Methyl Isobutyl Ketone (MIBK, CAS No. 108-10-1) to render a solution having a solids content of 17.5% by weight.

The curing component was added as a solution which consisted of 1.0 wt. parts of Casabond TX (bis-[isocyanatopheny] methane CAS No. 202-68-8, 53% in xylene CAS No. 1330-20-7) and 0.2 wt. parts of ZDMDC (zinc dimethyldithiocarbamate, CAS #137-30-4) to 40 wt. parts of the solvent solution.

Solvent solution of Example 1 cured within 2 to 3 days at room temperature. The phenolic resin is an essential ingredient in this formulation. Similar versions made without a phenolic resin or with only 1 part of phenolic resin did not cure.

The coating was used on a 55 durometer natural rubber compound which had been treated with Chemlok 7701. It was then compared against commercial fluorocarbon coating PLV-2100 available from Pelseal Technologies, LLC, and Lord's proprietary HNBR coating SPE-XV, both baked and unbaked made per U.S. Pat. No. 5,314,955 and an uncoated control.

When immersed in Jet A fuel for 24 hours at room temperature, the following volume swell results were recorded:

| Example | % swell in Jet A fuel |
|---|---|
| Uncoated | 192.9% |
| PLV 2100 commercial coating | 0.1% |
| SPE XV (baked) ex. Lord Corp. | 33.6% |
| HNBR SPE XV (unbaked) | 133.9% |
| Coating-of Example 1 | 6.2% |

The PLV 2100 coating provides the best barrier while the unbaked SPE XV gives only minimal protection, showing that it does not cure without the bake. While the PLV 2100 fluorocarbon coating shows the best fuel resistance, it has very poor adhesion to the natural rubber substrate.

Rubber adhesion was tested by bonding two one-inch-wide rubber strips together, and by pulling them apart in a 180° peel. The rubber strips were made from a 55 durometer natural rubber compound which had been treated with Chemlok 7701. An approximate two-inch-long section was coated; each strip was placed in contact with each other and a 472 g weight applied to ensure intimate contact. The weight was left in place for ten minutes. After fourteen days, each strip was pulled apart in the Tinius and the forces recorded. The following table records the results.

| Coating Type | Rubber to Rubber Peel Results, Lbf |
|---|---|
| PLV 2100 | 2.03 |
| HNBR SPE XV (baked) | 8.52 |
| Example 1 | 16.19 |

Besides having low adhesion values, the PLV 2100 coating cracks and delaminates from the rubber surface after flexing. Unpierced DeMattia flex specimens (made from a 55 durometer natural rubber compound) were coated with these same coatings and flexed in accordance with ASTM D-813. The PLV-2100 coating was severely cracked and delaminated, exposing the substrate in less than 4000 cycles. Both the baked HNBR SPE XV and Example 1 ran 80,000 cycles at which point the natural rubber substrate was cracked. There was no sign of delamination in either of these coatings.

It is understood that the foregoing description of preferred embodiments is illustrative, and that variations may be made in the present invention without departing from the spirit and scope of the invention. Although illustrated embodiments of the invention have been shown and described, a latitude of modification, change and substitution is intended in the foregoing disclosure, and in certain instances some features of the invention will be employed without a corresponding use of other features. Accordingly, it is appropriate that the appended claims are to be construed in a manner consistent with the scope of the invention.

What is claimed is:

1. A coating composition comprising 5 to 30 weight percent of solids, said solids comprising (a) a hydrogenated copolymer of a conjugated diene and an unsaturated nitrile, (b) a phenolic resin, (c) a di- or polyisocyanate, (d) a curing component, and (e) from 70 to 95% of a solvent.

2. A coating composition according to claim 1 wherein the conjugated diene is selected from the group consisting of 1,3-butadiene; 2,3-dimethylbutadiene; 1,3-pentadiene; 1,3-hexadiene; 2,4-hexadiene; 1,3-heptadiene; piperylene; and isoprene.

3. A coating composition according to claim 2 wherein the conjugated diene is 1,3-butadiene.

4. A coating composition according to claim 1 wherein the unsaturated nitrile corresponds to the following formula: 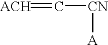
wherein each a is hydrogen or a hydrocarbyl group having from 1 to about 10 carbon atoms.

5. A coating composition according to claim 1 wherein the unsaturated nitrile is acrylonitrile or methacrylonitrile.

6. A coating composition according to claim 1 wherein the hydrogenated copolymer has an unsaturation level between about 0.1 and 20 mole percent.

7. A coating composition according to claim 6 wherein the unsaturation level is between about 3 and 7 mole percent.

8. A coating composition according to claim 1 wherein the phenolic resin is prepared by reacting a phenolic compound with an aldehyde compound under acidic, neutral or basic conditions with an appropriate catalyst.

9. A coating composition according to claim 8 wherein the phenolic compound is selected from the group consisting of phenol, p-t-butylphenol, p-phenylphenol, m-bromophenol, o-chlorophenol, p-chlorophenol, p-alkoxyphenol, o-cresol, m-cresol, p-cresol, 2-ethylphenol, amylphenol, nonylphenol, xylenol, naphthol, carvacrol, cashew nutshell liquid, resorcinol, orcinol, phloroglucinol, pyrocatechol, pyrogallol, salicylic acid, bisphenol A, bisphenol S, and combinations thereof.

10. A coating composition according to claim 9 wherein the phenolic compound is phenol.

11. A coating composition according to claim 8 wherein the aldehyde compound is selected from the group consisting of formaldehyde, acetaldehyde, propionaldehyde, isobutyraldehyde, 2-ethylbutrylaldehyde, 2-methylpentaldehyde, 2-ethylhexaldehyde, para-formaldehyde, trioxane, furfural, hexamethylenetetramine, and benzaldehyde.

12. A coating composition according to claim 11 wherein the aldehyde compound is formaldehyde.

13. A coating composition according to claim 1 wherein the curing component comprises elemental sulfur in combination with an organic accelerator.

14. A coating composition according to claim 13 wherein the organic accelerator is a derivative of a dithocarbamic acid, a xanthogenic acid, or a thiuram sulfide.

15. A coating composition according to claim 13 wherein the organic accelerator is selected from the group consisting of zinc dimethyldithiocarbamate, benzothiazyl disulfide, zinc isopropyl xanthate, N-pentamethylene-ammonium-N′-pentamethylenedithiocarbamate, and combinations thereof.

16. A coating composition according to claim 15 wherein the organic accelerator is a combination of zinc dimethyldithiocarbamate and benzothiazyl disulfide.

17. A coating composition according to claim 1 wherein the solvent is selected from the group consisting of ketones; acetates; toluene, xylene and their derivatives; nitropropane; and ethylene dichloride.

18. A coating composition according to claim 1 wherein the phenolic resin is present in an amount ranging from about 3 to 50 percent by weight of the hydrogenated copolymer and the curing component is present in an amount ranging from about 0.1 to 12 percent by weight of the hydrogenated copolymer.

19. A coating composition according to claim 18 wherein the phenolic resin is present in an amount ranging from about 5 to 15 percent by weight of the hydrogenated copolymer, the curing component is present in an amount ranging from about 1 to 6 percent by weight of the hydrogenated copolymer, and wherein the coating composition has a total solids content ranging from about 13 to 18 percent.

20. The coating composition of claim 1 wherein said di- or polyisocyanates is selected from the group consisting of as 1,6-hexamethylene diisocyanate; 1,8-octamethylene diisocyanate;1,12-dodecamethylene diisocyanate;2,2,4-trimethylhexamethylene diisocyanate, and the like; 3,3′-diisocyanatodipropyl ether; 3-isocyanatomethyl-3,5,5′-trimethylcyclodexyl isocyanate; hexamethylene diisocyanate; 4,4′-methylenebis(cyclohexyl isocyanate); cyclopentalene-1,3-diisocyanate;cyclodexylene-1,4,-diisocyanate; methyl 2,6-diisocyanatocaprolate; bis-(2-isocyanatoethyl)-fumarate; 4-methyl-1,3-diisocyanatocyclohexane; trans-vinylene diisocyanate; 4,4′-methylene-bis(cyclohexylisocyanate); methane diisocyanates; his-(2-isocyanatoethyl) carbonate; N,N′,N″-tris-(6-isocyanatohexamethylene)biuret, toluene diisocyanates; xylene diisocyanates; dianisidine diisocyanate; 4,4′-diphenylmethane diisocyanate; 1-ethoxy-2,4-diisocyanatobenzene; 1-chloro-2,4-diisocyanatobenzene; bis(4-isocyanatophenyl)methane; tris(4-isocyanatophenyl)methane; naphthalene diisocyanate; 4,4′-biphenyl diisocyanate; m-phenylene diisocyanate; p-phenylene diisocyanate; 3,3′-dimethyl-4,4′-biphenyl diisocyanate; p-isocyanatobenzoyl isocyanate; tetrachloro-1,3-phenylene diisocyanate; 2,4-toluene diisocyanate,2,6-toluene diisocyanate, 4,4′-isocyanate,bis-[isocyanatopheny] methane polymethylene poly(phenyl isocyanate), isophrone diisocyanate, mixtures thereof.

21. The coating of claim 1 wherein said di- or polyisocyanate is present at from 3 to 30 wt. parts per 100 wt. parts of said hydrogenated copolymer of a conjugated diene and an unsaturated nitrile.

22. The coating of claim 1 wherein said di- or polyisocyanate is present at from 8 to 15 wt. parts per 100 wt. parts of said hydrogenated copolymer of a conjugated diene and an unsaturated nitrile.

23. A method of coating a substrate comprising applying a coating composition to the surface of the substrate wherein the coating composition comprises the coating composition of claim 1.
